(19) United States
(12) Patent Application Publication
(10) Pub. No.: US 2007/0014291 A1
(43) Pub. Date: Jan. 18, 2007

(54) Method for multimedia broadcast/multicast service registration

(76) Inventor: Hai Zhang, Shenzhen (CN)

Correspondence Address: CHRISTIE, PARKER & HALE, LLP, PO BOX 7068, PASADENA, CA, 91109-7068, US

(21) Appl. No.: 11/483,199

(22) Filed: Jul. 7, 2006

Related U.S. Application Data
(63) Continuation of application No. PCT/CN05/00025, filed on Jan. 7, 2005.

(30) Foreign Application Priority Data
Jan. 8, 2004 (CN) 200410000170.6

(51) Int. Cl. H04L 12/56

(52) U.S. Cl. 370/390; 370/401

(57) ABSTRACT

A method for Multimedia Broadcast/Multicast Service (MBMS) Registration. Once the Broadcast/Multicast Service Center (BM-SC) receives the MBMS Registration Request from a Gateway GPRS Support Node (GGSN), it adds an identifier of the GGSN to the BM-SC's MBMS Bearer Context, and responds with an MBMS Registration Response comprising information of the MBMS Bearer Context to the GGSN; the GGSN receives the MBMS Registration Response and finishes creation of an MBMS Bearer Context based on the information of the MBMS Bearer Context which is comprised in the MBMS Registration Response. If the MBMS Bearer Context in upstream node that received MBMS Registration Request is in “Active” state, the upstream node will initiate Session Start procedure after a preset period of time when it finishes sending MBMS Registration Response.

### CROSS-REFERENCE TO RELATED PATENT APPLICATION

This application is a Continuation Application of International Application Number PCT/CN2005/000025, filed on Jan. 7, 2005, which claims priority of Chinese Patent Application Number 200410000170.6, filed on Jan. 8, 2004.

### FIELD OF THE TECHNOLOGY

The present invention relates to Multimedia Broadcast/Multicast service, and more particularly, to a method for Multimedia Broadcast/Multicast Service Registration.

### BACKGROUND OF THE INVENTION

Development of the 3^{rd} Generation Mobile Communication Technology makes it possible to provide services with a higher data transfer speed than the 2^{nd} Generation Mobile Communication does, and further support many new services, such as video telephone, downloading pictures and high speed Internet browsing etc. Wherein, some services have following common features: it is possible to send corresponding data simultaneously to all subscribers who have customized the service in radio network, for instance, sending weather forecast, short newsreel and sports performance collection etc. Based on the feature that data of these services can be sent simultaneously, the 3^{rd} Generation Mobile Communication introduces the concept of Multicast/Broadcast. Multicast refers to a source node forwards data a downstream node in single path, and then this downstream node replicates the data into several copies according to the number of its downstream nodes that need to receive the data, and further allocates the data to these downstream nodes, in this way, the nodes which received the data further replicate and distribute the data. Broadcast refers to a source node sends data to all downstream nodes. Transmission mechanism in Multicast mode is shown in FIG. 1, Node 1 is the source node, it sends data to its downstream Node 2; after receiving the data, Node 2 duplicates the said data and allocates to its downstream Nodes 20 and 21; after receiving the data, Node 20 duplicates the data and further allocates the copies to its downstream Nodes 201 and 202, and on the rest may be deduced by analogy.

FIG. 2 is a schematic diagram illustrating architecture of radio network which supports Multicast/Broadcast service. As shown in FIG. 2, in the 3^{rd} Generation Partnership Project (3GPP) frame, the network architecture of the radio network which supports Multicast/Broadcast service is: Broadcast-Multicast Service Center (BM-SC) 201 connects with Gateway GPRS Support Node (GGSN) 202 through Gmb interface or Gi interface, where one BM-SC 201 can connect with several GGSN 202; GGSN 202 connects with Serving GPRS Support Node (SGSN) 203 through Gn/Gp interface, where one GGSN 202 can connect with several SGSN 203; SGSN 203 can connect with Universal Terrestrial Radio Access Network (UTRAN) 204 of Universal Mobile Telecommunication System (UMTS) via Iu interface; UTRAN 204 connects with User Equipment (UE) 206 through Uu interface, SGSN 203 can also connect with GSM/EDGE Radio Access Network (GERAN) 205 in Global System of Mobile communication (GSM) via Iu/Gb interface; GERAN 205 connects with UE 207 via Um interface.

Benefits of adopting Broadcast and Multicast to transmit data are as follows: Broadcast and Multicast data can be transmitted only once in each link of radio communication network. For instance, a SGSN sends data to a Radio Network Controller (RNC) only once, no matter how many Base Stations (Node B) and UEs expect to receive these data. In this way, when the UEs which have registered for a particular Multicast/Broadcast service belong to a same cell, it is possible to send data to these UEs simultaneously through a Downlink Shared Channel, avoiding creating separate radio channel for each UE, such that reduces occupation of radio resources, thereby avoiding jamming radio interface with identical data, and further effectively increasing the capacity of radio interface.

Just because of many benefits of adopting Broadcast and Multicast in data delivery, Multimedia Broadcast/Multicast Service (MBMS) has rapidly developed and become widespread in the 3^{rd} Generation Mobile Communication system. The architecture of radio network in MBMS bearer service is identical with that shown in FIG. 2.

In radio communication network, MBMS Registration refers to the procedure by which a downstream node informs an upstream node that it would like to receive session attributes and data which will be further distributed to downstream nodes of a particular MBMS bearer service. This procedure builds up a distribution tree for the delivery of MBMS session attributes and data from the BM-SC to the UEs which are interested in the service, further results in the set-up of a corresponding MBMS Bearer Context along the nodes of the distribution tree, but it does not result in the establishment of a bearer plane which will be established by a Session Start procedure.

MBMS Bearer Context includes all information for describing a particular MBMS bearer service and is created in each node involved in the delivery of the MBMS data. MBMS Bearer Context comprises two states: “Active” and “Standby”. Wherein, “Active” reflects the state that bearer plane resources are required in the network for the transfer of the MBMS data, “Active” state is corresponding to the ongoing MBMS session. While “Standby” reflects the state of an MBMS Bearer Context in which bearer plane resources are not required in the network for the transfer of the MBMS data. This state is maintained as long as there is no ongoing corresponding MBMS session.

As shown in FIG. 3, the implementation of MBMS Registration procedure in prior art is as follows:

Step 301: When a drift RNC (DRNC) detects that the UE which is hosted by itself is interested in a particular MBMS bearer service, the DRNC sends an MBMS Registration Request to its parent SGSN if the registration has not been already done.

Step C1 and Step 302: If the SGSN has no MBMS Bearer Context for the MBMS bearer service and the SGSN receives an MBMS Registration Request from the DRNC for the MBMS bearer service; or if a first MBMS UE Context has been created in the SGSN for the MBMS bearer service, however the SGSN has no corresponding MBMS Bearer Context, the SGSN creates an MBMS Bearer Context (in “Standby” state) and sends an MBMS Registration Request which includes IP multicast address and APN to the GGSN. Here, the SGSN creates an MBMS Bearer Context. However, this MBMS Bearer Context does not comprise some information, such as Temporary Mobile Group Identity (TMGI), Required MBMS Bearer Capabilities etc.

Step 303: If the GGSN has no MBMS Bearer Context for the MBMS bearer service, and the GGSN receives an MBMS Registration Request from the SGSN for the MBMS bearer service, or if a first MBMS UE Context has been created in the GGSN for the MBMS bearer service, however the GGSN has no MBMS Bearer Context, the GGSN sends an MBMS Registration Request which includes IP multicast address and APN to a BM-SC.

Step 304: Upon reception of the MBMS Registration Request from the GGSN, the BM-SC adds the identifier of the GGSN to the “List of downstream nodes” parameter in its MBMS Bearer Context, and responds with an MBMS Registration Response which includes parameters such as TMGI, Required MBMS Bearer Capabilities etc. If the MBMS Bearer Context of the BM-SC is in “Active” state, the BM-SC will initiate a Session Start procedure with the GGSN.

Step 305 and Step C2: If the GGSN receives an MBMS Registration Request from the SGSN in Step 302, the GGSN adds the identifier of the SGSN to the “List of downstream nodes” parameter in its MBMS Bearer Context, and responds to the SGSN with MBMS Registration Response which includes parameters such as TMGI, Required MBMS Bearer Capabilities etc. If the MBMS Bearer Context is in “Active” state, the GGSN will initiate the Session Start procedure with the SGSN. Wherein, after receiving MBMS Registration Response from the GGSN, the SGSN fills TMGI, Required MBMS Bearer Capabilities parameters etc. therein according to the information included in the response message, finishes creation of the MBMS Bearer Context for the MBMS bear service in the SGSN.

Step 306: If the SGSN receives the MBMS Registration Request from the DRNC, the SGSN adds the identifier of the DRNC to the “List of downstream nodes” parameter of its MBMS Bearer Context, and responds with an MBMS Registration Response. If the MBMS Bearer Context is in “Active” state, the SGSN will initiate the Session Start procedure with the DRNC.

In view of the above description, there is no corresponding MBMS Bearer Context having been created in the GGSN during the MBMS Registration procedure in prior art. In MBMS, if no corresponding MBMS Bear Context has been created in the GGSN, it is impossible to establish continuous distribution tree, which is started from a BM-SC, ended at the service related UEs, and can send session attributes and data of the MBMS bearer service. Therefore, no MBMS bearer service will be implemented.

Moreover, the above procedure does not specify a clear time that initiates a session between an upstream node and a downstream node when the upstream node has service. Therefore, if the upstream node initiates a session before the downstream node having finished creation of the MBMS Bear Context therein, errors will occur and MBMS bearer service will be implemented normally.

### SUMMARY OF THE INVENTION

In view of the above, the present invention is to provide a method for Multimedia Broadcast/Multicast service registration in order to enable the MBMS to be implemented normally.

In accordance with one aspect of the present invention, a method for Multimedia Broadcast/Multicast Service (MBMS) Registration, comprises:

a Broadcast/Multicast Service Center (BM-SC) receives an MBMS Registration Request from a Gateway GPRS Support Node (GGSN), adds an identifier of the GGSN to the BM-SC's MBMS Bearer Context, and responds with an MBMS Registration Response comprising information of the MBMS Bearer Context to the GGSN; upon reception of the MBMS Registration Response, the GGSN finishes creation of an MBMS Bearer Context based on the information of the MBMS Bearer Context which is comprised in the MBMS Registration Response.

When responds with the MBMS Registration Response, the BM-SC initiates a Session Start procedure with the GGSN after a preset period of time if the MBMS Bearer Context is in “Active” state.

If the MBMS Bearer Context is in “Active” state while the GGSN responds with the MBMS Registration Response to the SGSN, the GGSN initiates Session Start procedure with the SGSN after a preset period of time. If the MBMS Bearer Context is in “Active” state while the SGSN responds with an MBMS Registration Response, the SGSN initiates Session Start procedure with the DRNC after a preset period of time.

Preferably, the GGSN determines IP multicast address and APN, creates an MBMS Bearer Context based on the determined IP multicast address and APN, and sets the MBMS Bearer Context in “Standby” state;

the GGSN fills the MBMS Bearer Context based on the TMSI, Required Bearer Capabilities parameters which are comprised in the response message from the BM-SC, finishes creation of the MBMS Bearer Context.

Preferably, the GGSN determines IP multicast address and APN, creates a full MBMS Bearer Context based on the determined IP multicast address and APN, as well as TMSI, Required Bearer Capabilities parameters in the response message.

According to the other aspect of the present invention, a method for Multimedia Broadcast/Multicast Service (MBMS) Registration implements as follows:

when an upstream node gets an MBMS registration from a downstream node, the upstream node adds an identifier of the downstream node to it's MBMS Bearer Context and notifies the downstream node, the downstream node finishes creation of an MBMS Bearer Context therein based on the information of the MBMS Bearer Context got from the upstream node.

Preferably, the upstream node adds an identifier of the downstream node to a “List of downstream nodes” parameter in its MBMS Bearer context.

Preferably, the upstream node initiates a Session Start procedure with the downstream node after a preset period of time when the MBMS Bearer Context is in “Active” state.

Preferably, the upstream node gets an MBMS registration from a downstream node is performed by reception of an MBMS Registration Request from the downstream node.

Preferably, the upstream node notifies the downstream node is performed by sending an MBMS Registration Response comprising the MBMS Bearer Context to the downstream node.

In the present invention, after receiving the Registration Response from the BM-SC, the GGSN creates a full MBMS Bearer Context and implements MBMS Bearer Context creation function in the MBMS Registration procedure. If the MBMS Bearer Context in the upstream node that received MBMS Registration Request is in “Active” state, the node will initiate Session Start procedure after a preset period of time when it finishes responding with the MBMS Registration Response, thereby avoiding errors occurring while the upstream node initiating Session Start procedure at the time when creating MBMS Bearer Context is uncompleted in its downstream nodes.

### BRIEF DESCRIPTION OF THE DRAWINGS

FIG. 1 is a schematic diagram illustrating transmission mechanism in Multicast mode;

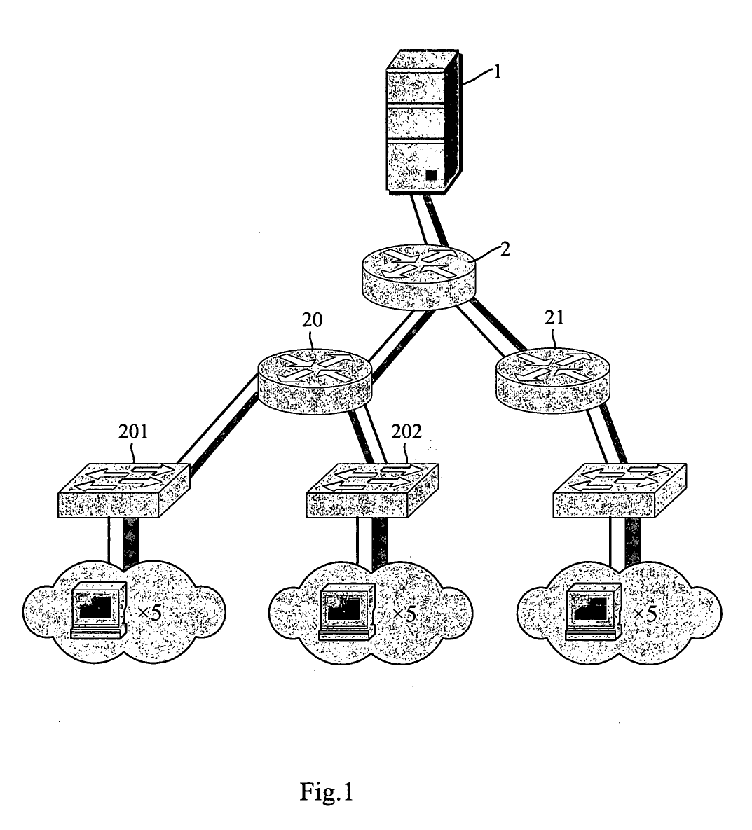

FIG. 2 is a schematic diagram illustrating architecture of radio network that supports Multicast/Broadcast service;

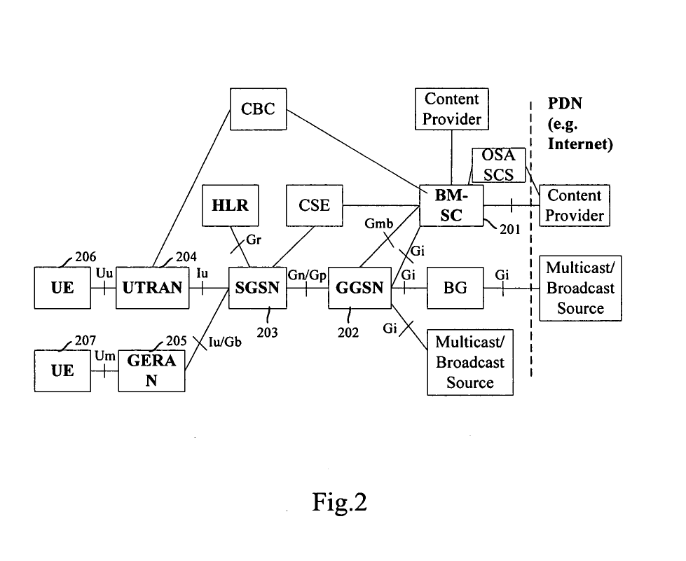

FIG. 3 is a schematic flowchart illustrating MBMS Registration procedure in the prior art;

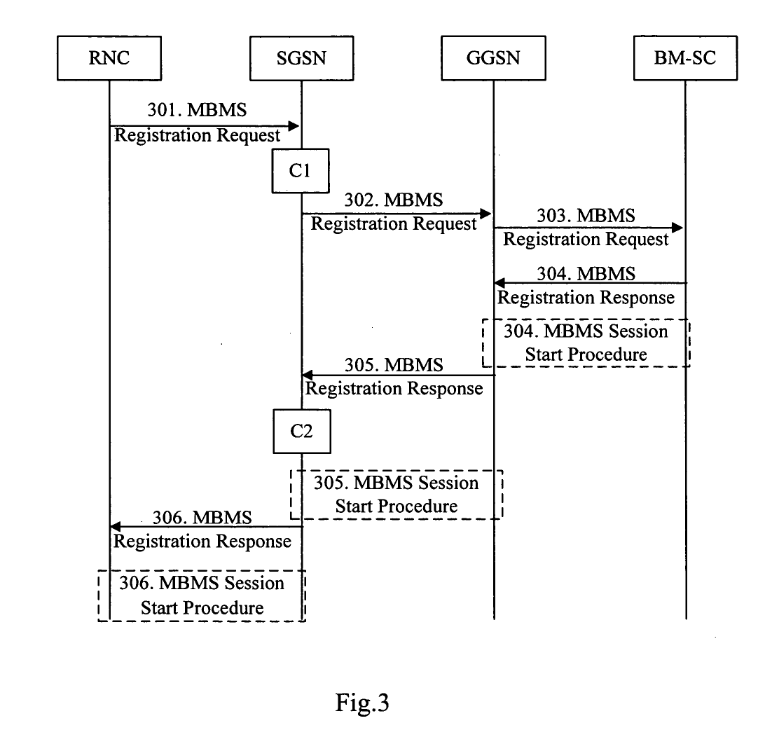

FIG. 4 is a schematic flowchart illustrating implementing MBMS Registration procedure in accordance with a first embodiment of the present invention;

FIG. 5 is a schematic flowchart illustrating implementing MBMS Registration procedure in accordance with a second embodiment of the present invention.

### EMBODIMENTS OF THE INVENTION

The present invention creates an MBMS Bearer Context in a GGSN when the GGSN has initiated MBMS Registration Request, thereby ensuring normal implementing of an MBMS bearer service.

It should be clear that, according to the MBMS Registration procedure in prior art, the BM-SC saves the MBMS Bearer Context information, which includes IP multicast address, APN, TMGI, State, Required MBMS Bearer Capabilities, QoS, MBMS Service Area, List of downstream nodes and number of UEs. As shown in Table 1, IP multicast address is for identifying the MBMS bearer service which is described by the MBMS Bearer Context; APN refers to Access Point Name defined by this IP multicast address, TMGI refers to Temporary Mobile Group Identity allocated to the MBMS bearer service; State is the state of bearer plane resources, i.e., “Standby” or “Active” state; Required MBMS Bearer Capabilities refers to minimum bearer capabilities that the UE needs to support; QoS means Quality of Service which is required for the MBMS bearer service; MBMS Service Area is the area over which the MBMS bearer service has to be distributed.; List of downstream nodes refers to the List of downstream nodes that have Required the MBMS bearer service and to which notifications and MBMS data have to be forwarded; and number of UEs means the number of UEs hosted by the node that have joined the MBMS bearer service. Wherein, “X” indicates the parameter that needs to be saved in corresponding nodes.

TABLE 1

| Parameter | Description | RAN | SGSN | GGSN | BM-SC |
|---|---|---|---|---|---|
| IP multicast | IP multicast address identifying the MBMS | X | X | X | X |
| address | bearer described by this MBMS Bearer | | | | |
| | Context. | | | | |
| APN | Access Point Name on which this IP | X | X | X | Undetermined |
| | multicast address is defined. | | | | |
| TMGI | Temporary Mobile Group Identity allocated | X | X | X | X |
| | to the MBMS bearer service. | | | | |
| State | State of bearer plane resources (“Standby” | Undetermined | X | X | X |
| | or “Active”) | | | | |
| Required | Minimum bearer capabilities the UE needs | | X | X | X |
| MBMS | to support | | | | |
| Bearer | | | | | |
| Capabilities | | | | | |
| QoS | Quality of Service required for the MBMS | X | X | X | X |
| | bearer service. | | | | |
| MBMS | Area over which the MBMS bearer service | X | X | X | X |
| Service Area | has to be distributed. | | | | |
| List of | List of downstream nodes that have | | X | X | X |
| downstream | requested the MBMS bearer service and to | | | | |
| nodes | which notifications and MBMS data have | | | | |
| | to be forwarded. | | | | |
| Number of | Number of UEs hosted by the node that | Undetermined | X | X | Undetermined |
| UEs | have joined the MBMS bearer service. | | | | |

After the UE initiating MBMS Registration Request which includes IP multicast address and APN, the IP multicast address and APN associated with the UE will be recorded in each node that the request passed. Therefore, after receiving the MBMS Registration Request from the downstream node, i.e. the SGSN, the GGSN will also possess the IP multicast address and APN. Moreover, if the first MBMS UE Context has been created in the corresponding node for the MBMS bearer service, however the node has no MBMS Bearer Context, it will also possess the IP multicast address and APN at this time. In this instance, it is necessary for the GGSN to initiate MBMS Registration Request, and obtain TMGI and Required MBMS Bearer Capabilities from the BM-SC based on the IP multicast address and APN. Because of the IP multicast address and APN that the GGSN can obtain by itself, the GGSN can adopt the following method to create the MBMS Bearer Context.

One preferred method according to the present invention now is described as follows. Upon receiving the MBMS Registration Response from the BM-SC, the GGSN creates a full MBMS Bearer Context, thereby finishing the creation of an MBMS Bearer Context function at GGSN during MBMS Registration procedure. If the MBMS Bearer Context in the upstream node that received MBMS Registration Request is in “Active” state, the upstream node will initiate Session Start procedure after a preset period of time when it finishes responding with the MBMS Registration Response.

Another preferred method according to the present invention will be described as follows. MBMS Bearer Context creation process in the GGSN will be divided into two steps. The first step is that, the GGSN creates MBMS Bearer Context according to the IP multicast address and APN before receiving the MBMS Registration Response. The second step is that, after receiving the MBMS Registration Response, the GGSN will go on with creation of the MBMS Bearer Context based on the TMGI, Required MBMS Bearer Capabilities parameters etc. in the response message.

The invention is hereinafter described in detail with reference to the accompanying drawings and exemplary embodiments so that the object, solution, and merits thereof could be made more apparent.

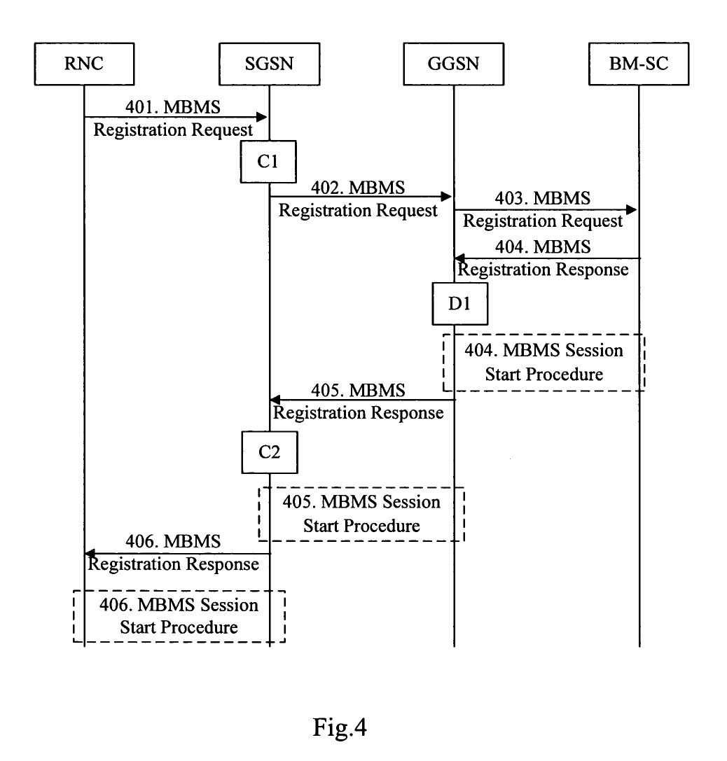

Now referring to FIG. 4, the method for implementing the present invention includes following steps:

Step 401 and Step C1: When a DRNC detects that a UE which is hosted by itself is interested in a particular MBMS bear service, the DRNC sends an MBMS Registration Request to its parent SGSN if the registration has not been already done. The MBMS Registration Request includes parameters for identifying the MBMS bearer service, i.e. IP multicast address and APN.

Step 402: If the SGSN has no MBMS Bearer Context for the MBMS bearer service, and the SGSN receives the MBMS Registration Request from the DRNC, or if a first MBMS UE Context has been created in the SGSN for the MBMS bearer service, however the SGSN has no corresponding MBMS Bearer Context, the SGSN creates an MBMS Bearer Context (in “Standby” state) based on the MBMS Registration Request or IP multicast address and APN included in the MBMS UE Context and sends an MBMS Registration Request which includes IP multicast address and APN to the GGSN. However, this MBMS Bearer Context does not include some information, such as TMGI, Required MBMS Bearer Capabilities etc.

Step 403: If the GGSN has no MBMS Bearer Context for the MBMS bearer service, and the GGSN receives the MBMS Registration Request from the SGSN for this MBMS bearer service, or if a first MBMS UE Context has been created in the GGSN for the MBMS bearer service, however the GGSN has no MBMS Bearer Context, the GGSN sends an MBMS Registration Request which includes IP multicast address and APN to the BM-SC.

Step 404 and Step D1: Upon reception of an MBMS Registration Request from the GGSN, the BM-SC adds the identifier of the GGSN to the “List of downstream nodes” parameter in its MBMS Bearer Context, and responds with an MBMS Registration Response, which includes parameters such as TMGI, Required MBMS Bearer Capabilities etc. After receiving the MBMS Registration Response, the GGSN creates the MBMS Bearer Context (in “Standby” state) based on the MBMS Bearer Context information included in the response message. If MBMS Bearer Context of the BM-SC is in “Active” state while the BM-SC responding with the response message, the BM-SC will initiate Session Start procedure with the GGSN after a preset period of time, thereby ensuring the GGSN to complete creation of the MBMS Bearer Context.

Step 405: If the GGSN receives the MBMS Registration Request from the SGSN in Step 402, the GGSN adds identifier of the SGSN to the “List of downstream nodes” parameter in its MBMS Bearer Context, and responds to the SGSN with an MBMS Registration Response which includes parameters such as TMGI, Required MBMS Bearer Capabilities etc.; after receiving the MBMS Registration Response from the GGSN, the SGSN fills TMGI, Required MBMS Bearer Capabilities parameters etc., based on the information included in the response message and completes creation of the MBMS Bearer Context for the MBMS bearer service in the SGSN. If the MBMS Bearer Context is in “Active” state while the GGSN responding with the response message, the GGSN will initiate Session Start procedure with the SGSN after a preset period of time, thereby ensuring the SGSN to complete creation of the MBMS Bearer Context.

Step 406: If the SGSN receives the MBMS Registration Request from the DRNC, the SGSN adds the identifier of the DRNC to the “List of downstream nodes” parameter of the MBMS Bearer Context, and responds with an MBMS Registration Response. If the MBMS Bearer Context is in “Active” state while the SGSN responding with response message, the SGSN will initiate Session Start procedure with the DRNC after a preset period of time, thereby ensuring the DRNC to complete creation of the MBMS Bearer Context.

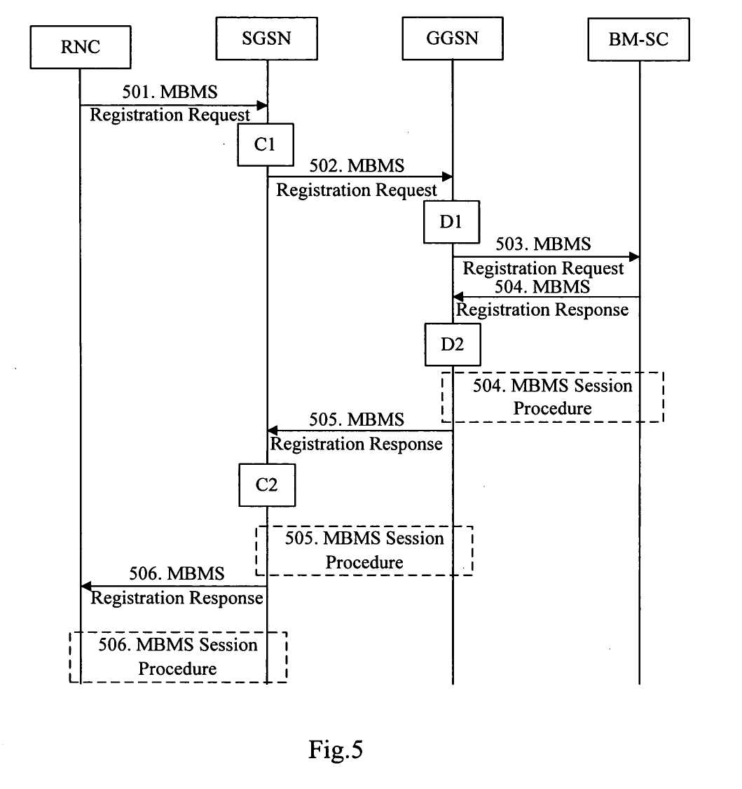

Now referring to FIG. 5, the invention will be described in more detail hereinafter.

Step 501: When a DRNC detects that a UE which is hosted by itself is interested in the MBMS bear service, the DRNC sends an MBMS Registration Request to its parent SGSN if the registration has not been already done. The MBMS Registration Request includes parameters for identifying the MBMS bearer service, i.e., IP multicast address and APN.

Step 502 and Step C1: If the SGSN has no MBMS Bearer Context for the MBMS bearer service, and the SGSN receives the MBMS Registration Request from the DRNC, or if a first MBMS UE Context has been created in the SGSN for the MBMS bearer service, however the SGSN has no corresponding MBMS Bearer Context, the SGSN creates an MBMS Bearer Context (in “Standby” state) based on the MBMS Registration Request or IP multicast address and APN included in the MBMS UE context and send an MBMS Registration Request which includes IP multicast address and APN to the GGSN. However, this MBMS Bearer Context does not include some information, such as TMGI, Required MBMS Bearer Capabilities etc.

Step 503 and Step D1: If the GGSN has no MBMS Bearer Context for the MBMS bearer service, and the GGSN receives the MBMS Registration Request from SGSN for the MBMS bearer service, or if a first MBMS UE Context has been created in the GGSN for the MBMS bearer service, however the GGSN has no MBMS Bearer Context, the GGSN creates an MBMS Bearer Context (in “Standby” state) based on the MBMS Registration Request or IP multicast address and APN included in the MBMS UE Context and sends an MBMS Registration Request which includes IP multicast address and APN to the BM-SC. However, this MBMS Bearer Context does not include some information, such as TMGI, Required MBMS Bearer Capabilities etc.

Step 504 and Step D2: Upon reception of the MBMS Registration Request from GGSN, the BM-SC adds an identifier of the GGSN to the “List of downstream nodes” parameter in its MBMS Bearer Context, and responds with an MBMS Registration Response, which includes parameters such as TMGI, Required MBMS Bearer Capabilities etc. After receiving MBMS Registration Response from the BM-SC, the GGSN fills TMGI, Required MBMS Bearer Capabilities parameters etc. according to the information included in the response message, finishes creation of the MBMS Bearer Context for the MBMS bear service in the GGSN. If MBMS Bearer Context of the BM-SC is in “Active” state while the BM-SC responding with the response message, the BM-SC will initiate Session Start procedure with the GGSN after a preset period of time, thereby ensuring the GGSN to finish creation of the MBMS Bearer Context.

Step 505 and Step C2: If the GGSN receives the MBMS Registration Request from the SGSN in Step 502, the GGSN adds identifier of the SGSN to the “List of downstream nodes” parameter in its MBMS Bearer Context, and responds to the SGSN with an MBMS Registration Response which includes parameters such as TMGI, Required MBMS Bearer Capabilities etc.; after receiving the MBMS Registration Response from the GGSN, the SGSN fills TMGI, Required MBMS Bearer Capabilities etc. according to the information included in the response message, finishes creation of the MBMS Bearer Context for the MBMS bearer service in the SGSN. If the MBMS Bearer Context is in “Active” state while the GGSN responding with the response message, the GGSN will initiate Session Start procedure with the SGSN after a preset period of time, thereby ensuring the SGSN to finish creation of the MBMS Bearer Context.

Step 506: If the SGSN receives the MBMS Registration Request from the DRNC, the SGSN adds the identifier of the DRNC to the “List of downstream nodes” parameter of the MBMS Bearer Context, and responds with an MBMS Registration Response; if the MBMS Bearer Context is in “Active” state while the SGSN responding with the response message, the SGSN will initiate Session Start procedure with the DRNC after a preset period of time, thereby ensuring the DRNC to finish creation of the MBMS Bearer Context.

In above procedure, the completion of MBMS Bearer Context creating process is divided into steps D1 and D2. Wherein, the procedure of Step D1 is that: GGSN creates an MBMS Bearer Context. However, this MBMS Bearer Context does not include some information, such as TMGI, Required MBMS Bearer Capabilities etc.; the procedure of Step D2 is that:

the GGSN receives an MBMS Registration Response from the BM-SC, and fills TMGI, Required Bearer Capabilities parameters etc. according to the information included in the response message, finishes creation of the MBMS Bearer Context for the MBMS bear service in the GGSN.

The above discussion discloses and describes merely preferred embodiments of the present invention, and not used to limit protection scope of the present invention. Any modifications, equal replacements and improvements which belong to this intention's spirit and rule, are all included in the protection scope hereinafter.

1. A method for Multimedia Broadcast/Multicast Service (MBMS) Registration, comprising steps of:
upon reception of an MBMS Registration Request from a Gateway GPRS Support Node (GGSN), a Broadcast/Multicast Service Center (BM-SC) adding an identifier of the GGSN to the BM-SC's MBMS Bearer Context, and responding with an MBMS Registration Response comprising information of the MBMS Bearer Context;
upon reception of the MBMS Registration Response, the GGSN finishing creation of an MBMS Bearer Context based on the information of the MBMS Bearer Context which is comprised in the MBMS Registration Response.

2. The method according to claim 1, wherein when responding with an MBMS Registration Response, if the MBMS Bearer Context is in “Active” state, the method further comprising:
the BM-SC initiating a Session Start procedure with the GGSN after a preset period of time.

3. The method according to claim 1, wherein if a first MBMS UE Context has been created in the GGSN for the MBMS bearer service, the method further comprising:
the GGSN detecting whether it has created the MBMS Bearer Context for the MBMS bearer service, if not, the GGSN sending an MBMS Registration Request comprising IP multicast address and Access Point Name (APN) to the BM-SC.

4. The method according to claim 1, further comprising:
a Serving GPRS Support Node (SGSN) creating an MBMS Bearer Context which is in “Standby” state, and sending an MBMS Registration Request comprising an IP multicast address and APN to the GGSN;
upon reception of the MBMS Registration Request, the GGSN detecting whether there is an MBMS Bearer Context for the MBMS bearer service in the GGSN; and if not, the GGSN sending an MBMS Registration Request comprising an IP multicast address and APN to the BM-SC.

5. The method according to claim 4, wherein when a drift Radio Network Controller (DRNC) detects that a UE hosted by itself is interested in the MBMS bearer service, and the DRNC has not registered for the MBMS bearer service, the method further comprising:
the DRNC sending an MBMS Registration Request to its parent SGSN;
upon reception of the MBMS Registration Request, the SGSN detecting whether there is an MBMS Bearer Context for the MBMS bearer service, and if not, going to the step of creating an MBMS Bearer Context and sending the MBMS registration to the GGSN.

6. The method according to claim 4, wherein if a first MBMS UE Context has been created in the SGSN for the MBMS bearer service, the method further comprising:
detecting whether an MBMS Bearer Context has been created in the SGSN for the MBMS bearer service, and if not, going to the step of creating an MBMS Bearer Context and sending the MBMS Registration Request to the GGSN.

7. The method according to claim 4, further comprising:
the GGSN adding the identifier of the SGSN to a “List of downstream nodes” parameter in the MBMS Bearer Context and responding with an MBMS Registration Response comprising TMGI, Required Bearer Capabilities parameters to the SGSN;
upon receiving the MBMS Registration Response, the SGSN filling TMGI, Required Bearer Capabilities according to the information which is comprised in the MBMS Registration Response, and finishing creation of the MBMS Bearer Context for the MBMS bearer service in the SGSN.

8. The method according to claim 7, wherein if the MBMS Bearer Context is in “Active” state while responding with the MBMS Registration Response to the SGSN, the method further comprising:
the GGSN initiating Session Start procedure with the SGSN after a preset period of time.

9. The method according to claim 7, when the SGSN receiving the MBMS Registration Request from the DRNC and after the step of the SGSN finishing creation of the MBMS Bearer Context for the MBMS bearer service, the method further comprising:
the SGSN adding the identifier of the DRNC to a “List of downstream nodes” parameter of the MBMS Bearer Context and responding with an MBMS Registration Response.

10. The method according to claim 9, if the MBMS Bearer Context is in “Active” state while the SGSN responding with an MBMS Registration Response, the method further comprising:
the SGSN initiating Session Start procedure with the DRNC after a preset period of time.

11. The method according to claim 1, further comprising:
the GGSN determining IP multicast address and APN, creating an MBMS Bearer Context based on the determined IP multicast address and APN, and setting the MBMS Bearer Context in “Standby” state;
the step of the GGSN creating an MBMS Bearer Context further comprising:
the GGSN filling the MBMS Bearer Context based on the TMSI, Required Bearer Capabilities parameters which are comprised in the response message, finishing creation of the MBMS Bearer Context.

12. The method according to claim 1, wherein, the step of the GGSN creating an MBMS Bearer Context further comprises:
the GGSN determining IP multicast address and APN, creating a full MBMS Bearer Context based on the determined IP multicast address and APN, as well as TMSI, Required Bearer Capabilities parameters in the response message.

13. A method for Multimedia Broadcast/Multicast Service (MBMS) Registration, comprising:
when an upstream node getting an MBMS registration from a downstream node, the upstream node adding an identifier of the downstream node to the upstream node's MBMS Bearer Context and notifying the downstream node; the downstream node finishing creation of an MBMS Bearer Context therein based on the information of the MBMS Bearer Context got from the upstream node.

14. The method according to claim 13, wherein the upstream node adding an identifier of the downstream node to a “List of downstream nodes” parameter in its MBMS Bearer context.

15. The method according to claim 13, wherein the upstream node initiating a Session Start procedure with the downstream node after a preset period of time when the MBMS Bearer Context is in “Active” state.

16. The method according to claim 13, wherein the upstream node is a Broadcast/Multicast Service Center (BM-SC), and the downstream node is a Gateway GPRS Support Node (GGSN).

17. The method according to claim 13, wherein the upstream node is a GGSN, and the downstream node is a Serving GRPS Support Node (SGSN).

18. The method according to claim 13, wherein the upstream node is a SGSN, and the downstream node is a Radio Network Controller.

19. The method according to claim 13, wherein an upstream node getting an MBMS registration from a downstream node is performed by reception of an MBMS Registration Request from the downstream node.

20. The method according to claim 16, wherein the upstream node notifying the downstream node is performed by sending an MBMS Registration Response comprising the MBMS Bearer Context to the downstream node.
